(19) United States
(12) Patent Application Publication
(10) Pub. No.: US 2005/0154735 A1
(43) Pub. Date: Jul. 14, 2005

(54) Resource management

(75) Inventors: Jochen Breh, Stuttgart (DE); Gerd Breiter, Wildberg (DE); Thomas Spatzier, Sindelfingen (DE)

Correspondence Address: Eugene I. Shkurko;IBM Corporation - MS P386, 2455 South Road, Poughkeepsie, NY, 12601, US

(73) Assignee: International Business Machines Corporation, Armonk, NY (US)

(21) Appl. No.: 11/016,621

(22) Filed: Dec. 17, 2004

(30) Foreign Application Priority Data
Dec. 19, 2003 (EP) 03104824.2

(51) Int. Cl. G06F 17/30

(52) U.S. Cl. 707/10

(57) ABSTRACT

A method, computer program, computer program product and apparatus for facilitating a user in the creation of a model describing how resources in a service environment are to be managed by a resource management system. A service environment description is received comprising information defining resources that may be managed by the resource management system. Information is then extracted from the description regarding services provided by at least some of the resources and the extracted information is presented to a user. The user is then able to use the extracted information to create the model by defining rules to manage at least some of the resources.

### RELATED APPLICATIONS

U.S. patent application DE9-2003-0044, entitled “Event Correlation System and Method for Monitoring Resources” filed concurrently herewith is assigned to the same assignee hereof and contains subject matter related, in certain respect, to the subject matter of the present application. The above-identified patent application is incorporated herein by reference.

### FIELD OF THE INVENTION

The invention relates to the management of resources in a services environment.

### BACKGROUND OF THE INVENTION

In recent years there has been an increasing trend for companies to outsource parts of their IT infrastructure to various forms of service providers. Initially, this form of IT outsourcing was done in a static fashion: providers assigned hard-wired configurations of resources to specific customers. New technologies, however, allow IT outsourcing to take place in a more dynamic manner. Various forms of service providers offer carrier-grade access to computing resources. The distinction between traditional IT outsourcing and the new model often adopted by service providers is that providers do not assign resources to a customer in a static way. Instead resources are shared and dynamically provisioned among several customers according to some basic policies.

When customers subscribe to such a service, a Service Level Agreement (SLA) between the customer and the provider defines certain quality of service (QoS) parameters that must be met by the system. An SLA could, for example, define that the response time of a system must not exceed a certain value, or that the round trip time of data packets on a network resource has to be within certain limits.

The provision of services that fulfil SLAs during both peaks and troughs in work load requires monitoring of QoS parameters and dynamic reconfiguration of systems in accordance with current loads. For example, to keep response times of a service within SLA parameters it might be necessary to increment the amount of resources allocated for the service in as necessary.

Several requirements are placed on a computing environment for hosting such services. Mechanisms are needed to optimize the utilization of resources in order to operate such services as economically as possible. QoS parameters stated in SLAs have to be monitored. Dynamic reconfiguration of application environments then has to be performed to maintain guaranteed QoS levels.

Such a service offered to a customer typically comprises several distinct components. These components include both physical resources (hardware, software etc.) as well as logical resources (for grouping a number of physical resources together under a common name). All resources which together perform a specific service form a service environment.

A common way to describe service environments is to define service environment descriptions (templates) (SETs) in the form of topology trees. These topology trees include all the “real” components which make up a service environment as well as logical components. For example, several physical components might be grouped to form a logical entity.

Another benefit offered by topology trees is the expression of logical and hierarchical dependencies between the different components of a service environment.

FIG. 1 shows an example of a topology tree for a secure web server service environment. Logical entities are depicted as circles, whilst physical entities are depicted as squares.

The whole web hosting environment 10 consists of a firewall 20, 50, a web server group 30 and an application server group 40. The web server group itself comprises a load balancer 60 and several web servers (one shown) 70. Each web server is made up of a computer 120, which runs an operating system 110 and a web server software program 100. Application server 90 is analogous to component 70, but running Application Server Software 130 instead of Web Server Software 100.

In order to make a service environment work in an autonomic fashion (i.e. to automatically adapt to current work loads using monitoring, automatic reconfiguration, etc.), a correlation model is typically defined for that service environment. This correlation model can be deployed into a management infrastructure where it is used to automatically manage the service environment.

Such a correlation model typically comprises several items:
i) Monitoring event definitions define which state changes of resources are important with respect to management;
ii) Rules define how the system will react in response to certain events
   As part of the rules there is a pointer to appropriate workflows/operations (actions) that can be triggered by rules in order to actively manage the service environment. The workflows/operations themselves are actually provided/implemented by the management infrastructure. Single operations may also be provided by managed resources.

When defining a correlation model for a service environment, a common way is to use a hierarchical approach—i.e. to define rules for managing parts (sub-systems) of the overall system (with the aim of making these parts autonomic) and then to define rules to integrate these sub-systems.

Using the example of illustrated by FIG. 1, it makes sense to define rules for managing the web server group in order to make it as autonomic as possible. These rules could, for example define that a new web server is to be added to the group, if all of the current web servers are overloaded. Similarly, a set of rules could be defined for managing the application server group. A higher-level set of rules could then be defined to integrate the rules of both the web server group and the application server group and to resolve any conflicts between the two subsystems. For instance, if the application server group requires an additional server, but there are no more resources available, the higher-level rules could check if a server can be removed from the web server group. In that case a rule could trigger a workflow that removes a server from the web server group, uninstalls the web server software, installs application server software and adds the new application server to the application server group.

Information that is needed for creating a correlation model as described above is already contained in the topology tree of an SET. The topology tree contains descriptions of resources (or resource classes) that will be used for implementing a service environment. These descriptions include Service Data Elements (SDEs) provided by each resource type. Such SDEs are name-value pairs and provide, for example, information regarding available quality of service or current levels of utilization. An SDE may, by way of example, be described using XML or WSDL. FIG. 2 shows an example of some SDEs that may be associated with the computer resource 120 of FIG. 1. In this example computer 120 has three SDEs 160: cpuIdleTime; FreeMemory; and FreeHardDisk. When initially modelled, the values between <xs:double> <xs:double/> for each SDE are left blank—the SDEs get their values when the computer executes.

Such SDEs can be used for defining monitoring events to which rules shall react. Such rules are defined by a user and they define how the management infrastructure is to react in certain situations.

Furthermore, resource descriptions include operations that can be invoked on resources. These operations can be invoked by management rules, or they can be used for composing workflows (a series of operations) that can be triggered by rules.

The creation of a correlation model can be a very complex and time consuming task. If a service environment consists of dozens of components, hundreds of low-level events may be provided by these resources making it hard for an administrator to select those events that are relevant for managing the system. Furthermore, the creation of a valid set of rules that correctly manage the system is a very complex and error-prone task. So far, a lot of work during the definition of a correlation model for service environments has to be done manually, since no integrated tooling support is available, yet.

That is to say no tooling exists that extracts all the valuable information contained in a topology tree of an SET and offers support during the creation of correlation models. Information has to be looked up manually with the mapping of events, rules and workflows against a certain service environment also having to be done in a manual way. No easy automatic sanity check against an existing topology tree exists so far. Furthermore, all rules are currently inserted into a huge monolithic set. This approach is extremely error-prone: the larger the number of rules in a set is, the higher the probability of conflicts between rules.

### SUMMARY

According to one aspect, there is provided a method for facilitating a user in the creation of a model describing how resources in a service environment are to be managed by a resource management system, the method comprising the steps of: receiving a service environment description comprising information defining resources that may be managed by the resource management system; automatically extracting information from the description regarding services provided by at least some of the resources; presenting a user with the extracted information; and facilitating the user in the creation of the model by permitting the user to define rules for managing at least some of the resources.

Thus the user is facilitated in the creation the model using information extracted from a service environment description. In this way, any created model should be syntactically and semantically valid. There is not the same opportunity for the user to mistype a name or to make a non-existent reference. Note, any created model may comprise variable parameters (e.g. blanks which can be filled in later according to input received). Of course any created model does not have to comprise variable parameters.

In a preferred embodiment the extracted information comprises service data elements, each service data element defining a service provided by a resource within the service environment (e.g. the ability for a computer to report and/or to be queried for its cpu idle time). In the preferred embodiment, the extracted information further comprises operations which may be invoked on the resources.

Preferably a rule when defined comprises an operation to be performed on execution of the rule.

Preferably the user is able to associate rules with certain resources. For example the service environment description may be presented to the user in the form of a topology tree with nodes in the tree representing physical resources or logical groupings of resources. It may, in this example, be possible to associate rules with certain nodes in the topology tree.

In accordance with a preferred embodiment, in order to define a rule the user is preferably able to define an event which triggers the execution of the rule.

In accordance with a preferred embodiment, a list of service data elements provided by at least one resources in the service environment description is presented to a user. Such service data elements preferably form the basis for event definitions.

In order to define events, the user preferably is able to associate values with at least some of the service data elements listed. For example, if one service data element is the representation of a computer's cpu idle time, then a value could be associated with a particular computer's cpu idle time to define that the user is interested when that computer's cpu idle time drops below 5%.

Thus a very simple list based interface is preferably provided to the user enabling the user to define rules through selection from such lists.

In accordance with a preferred embodiment, the model describing how the resources are to be managed is compiled into a machine readable form executable by said resource management system as a correlation model instance.

In one embodiment the created model includes variable parameters and input is received (from for example SLA(s) and/or provider policy(ies)) defining the values of the variable parameters. A correlation model definition is then output having values defined for said variable parameters in accordance with the input received. The output correlation model definition is preferably in a machine readable format executable by said resource management system as a correlation model instance.

In this way the same model describing how resources are to be managed may be used multiple times but to different effect—the effect being based on input received from, for example SLAs.

It will of course however be appreciated that this is not essential and that the description may not include any variable parameters.

Preferably at least one workflow is created to define how the correlation model is to be instantiated as a correlation model instance (e.g. which single steps have to be performed within a management infrastructure in order to get a running correlation model instance. Preferably the correlation model is instantiated and executed using at least one created workflow.

The created workflow(s) can be tailored to a particular infrastructure in which the description is executed.

In accordance with a preferred embodiment, it can be determined that a change is to be applied to an executing correlation model instance—in which case, a correlation model definition delta is preferably applied to the executing correlation model instance.

In this way it is not necessary to start from the beginning with a new description each time a change is required to be applied. Furthermore, it is not necessary to restart a customer's service environment in order to apply changes. Rather the delta can be used to modify a runtime version of a correlation model instance.

In a preferred embodiment, it is possible to create a correlation model template by defining rules for managing at least some of the resources, the correlation model template having variable parameters.

According to another aspect, there is provided a method for creating a correlation model definition describing how resources in a service environment are to be managed by a resource management system, the method comprising the steps of: receiving a correlation template having variable parameters (e.g. blanks that can be filled in according to specific policies); receiving input defining the values of said variable parameters in the correlation model template; and outputting a correlation model definition having values defined for said variable parameters in accordance with the input received.

In accordance with another aspect, there is provided an apparatus for facilitating a user in the creation of a model describing how resources in a service environment are to be managed by a resource management system, the apparatus comprising: means for receiving a service environment description comprising information defining resources that may be managed by the resource management system; means for automatically extracting information from the description regarding services provided by at least some of the resources; means for presenting a user with the extracted information; and means for facilitating the user in the creation of the model by permitting the user to define rules for managing at least some of the resources.

It will no doubt be appreciated that the present invention may be implemented as a computer program and/or as a computer program product stored on a computer readable medium.

### BRIEF DESCRIPTION OF THE DRAWINGS

A preferred embodiment of the present invention will now be described, by way of example only, and with reference to the following drawings:

FIG. 1 illustrates a server environment topology (SET) in accordance with the prior art;

FIG. 2 illustrates, in accordance with the prior art, Service Data Elements (SDEs) associated with the computing resource of FIG. 1.

FIG. 3 is a diagram of the components of the present invention, in accordance with a preferred embodiment;

FIG. 4 illustrates, in accordance with a preferred embodiment, the process for creating and attaching rule sets to nodes in the SET;

FIG. 5 shows, in accordance with a preferred embodiment, the process by which the Correlation Model Template (CMT) Editor of FIG. 3 collects data needed for rule set definition;

FIG. 6 depicts the process, in accordance with a preferred embodiment, by which events are defined;

FIG. 7 illustrates, in accordance with a preferred embodiment, the process of creating rules that are triggered by the previously defined events;

FIG. 8 is a flow chart of the process by which the Correlation Model Definition (CMD) Composer of FIG. 3 creates a CMD;

FIG. 9 is a flow chart of the deployment, in accordance with a preferred embodiment of the present invention, of a CMD into a Management Infrastructure; and

FIG. 10 illustrates the application of CMD deltas in accordance with a preferred embodiment of the present invention.

### DETAILED DESCRIPTION

The invention, in accordance with a preferred embodiment, provides an infrastructure including integrated tooling support that assists administrators during the creation of correlation models for service environments. Furthermore, this infrastructure preferably automates complex tasks (such as the customization of correlation models) in order to fulfil specific customer requirements as well as to enable the deployment of a correlation model into a management infrastructure.

Overview

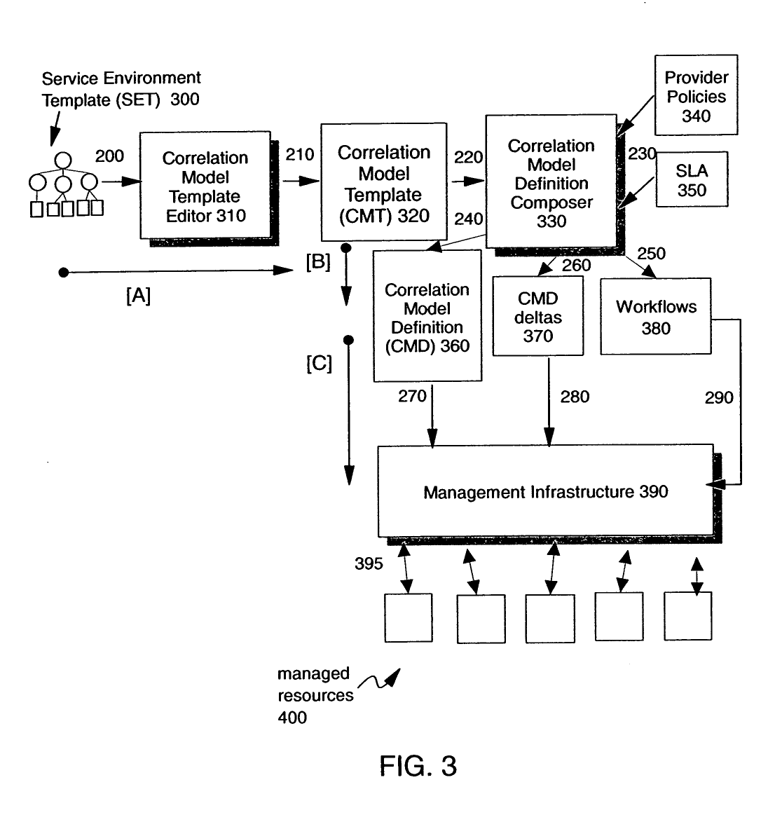

Described herein is a tooling infrastructure (see FIG. 3) that assists [A] in the creation of correlation models, [B] in the customization of correlation models and [C] in the deployment of correlation models into a management infrastructure.

An editor tool takes the description of a service environment, in the form of an SET topology tree 300, as an input and extracts all the information that is valuable for managing the system.

Note, not all the information in the SET is necessarily valuable for management purposes. An SET is typically defined in an XML-based language with specific elements denoted by < >. The editor is primed with which elements to look for—for example <serviceData>; <operations> etc.

The extracted information is then provided 200 to a correlation model template editor 310 for the creation 210 of a Correlation Model Template (CMT) 320. This CMT is a generic description of how a certain type of service environment (e.g. a secure web server environment) is to be managed. Several parts within the CMT are preferably left variable and this makes it possible to later produce a customized correlation model definition in accordance with the needs of a specific customer. (Note, this does not have to be the case.) For example, thresholds that define when resources are to be added to or removed from the service environment are left blank. These blanks will then be filled in later according to customer SLAs 350 and/or provider policies 340.

Customer A might, for example, have an SLA for a high-performance web service environment. Hence A's correlation model defines thresholds which ensure high performance. Customer B, on the other hand, might have an SLA for a lower-performance environment that allows larger system response times. Customer B's threshold can thus be more tolerant of lower performance.

The CMT 320 created using the CMT Editor 310 is then input 220 into a Correlation Model Definition Composer 330, which fills in all the variable parts of the CMT and creates 240 a Correlation Model Definition 360 (CMD) for a specific service environment of a specific customer.

This CMD preferably makes it possible for the service environment to be managed in such a way so as to fulfil specific policies and SLAs. These policies 340 and SLAs 350 are also taken as input 230 by the CMD Composer 330 and are used to fill in the variable parts of the CMT 320.

In addition to the CMD, the Composer 330 also creates 250 workflows 380 that are later used 290 for instantiating 270 the CMD as a correlation model instance in a specific correlation (management) infrastructure 390. (Within such an infrastructure sits a resource management system which uses an correlation model instance to manage certain resources defined therein.)

An instantiated correlation model provides the correlation infrastructure with information as to which resources under the control of the infrastructure should be managed and how they should be managed. The correlation infrastructure knows how to interpret such information.

Note, it is possible to instantiate many correlation models based on the same CMD. For example, one might be associated with customer A, whilst another is associated with customer B.

The correlation infrastructure 390 is thus able to manage 395 the resources 400 of a service environment according to an instantiated correlation model.

Furthermore, the CMD Composer 330 can be used to create CMD deltas 370 in the case that a customer's SLAs or provider policies change during the runtime of a service environment. If, for example, an SLA changes, the variable parts of a CMT will be filled in differently. These deltas to the original CMD are created by the Composer and can be applied, via the correlation infrastructure 280, to an instantiated correlation model without interrupting the operation of a customer's service environment.

Note, it will however be appreciated that such functionality may not exist just within the CMD Composer 330—there may, for example, be separate tool(s) for the creation of CMD deltas and workflows. It is however preferably that this functionality is contained within the CMD Composer—see later.

The operation of the present invention will now be described in more detail.

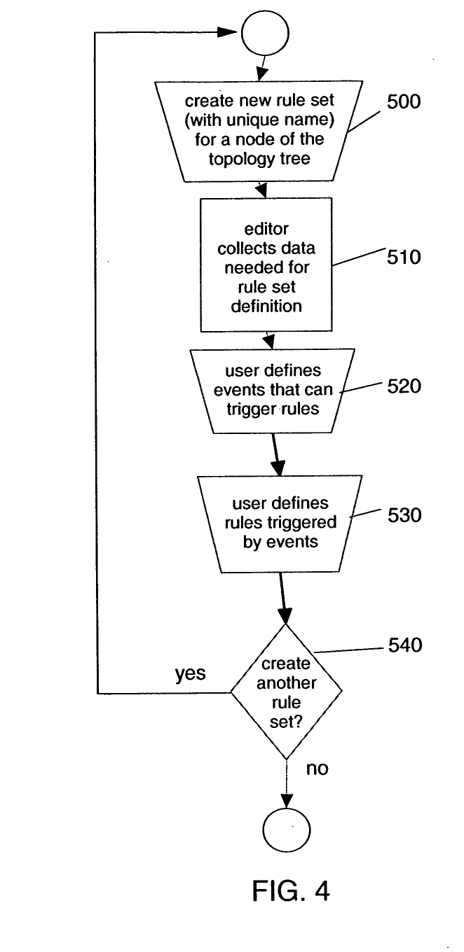

Creation of Correlation Model Template (Arrow [A] in FIG. 4)

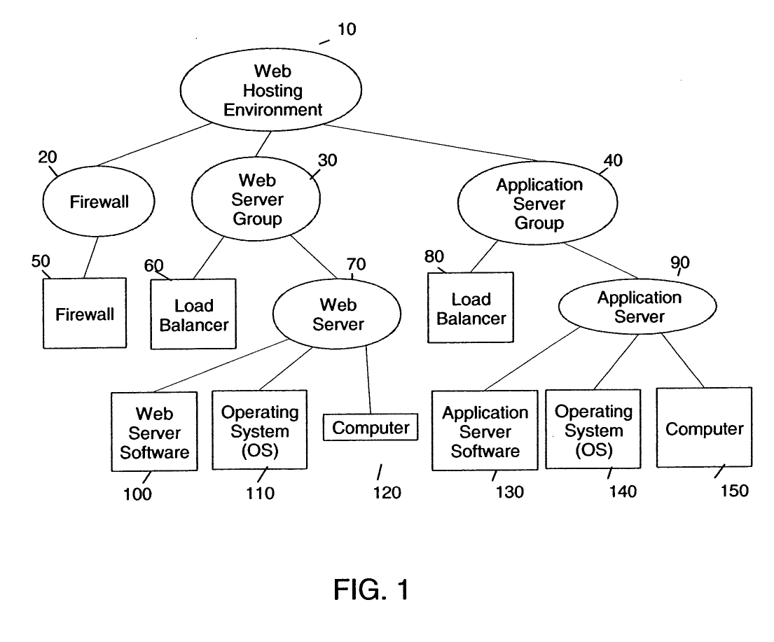

As mentioned above the correlation model template is preferably created in a hierarchical way. Sets of rules are created and associated to sub trees of the overall topology tree. These rule sets are used to manage the respective sub systems and to make the sub system autonomic. For example a rule set can be defined for managing the web server group of the secure web server environment (see FIG. 1).

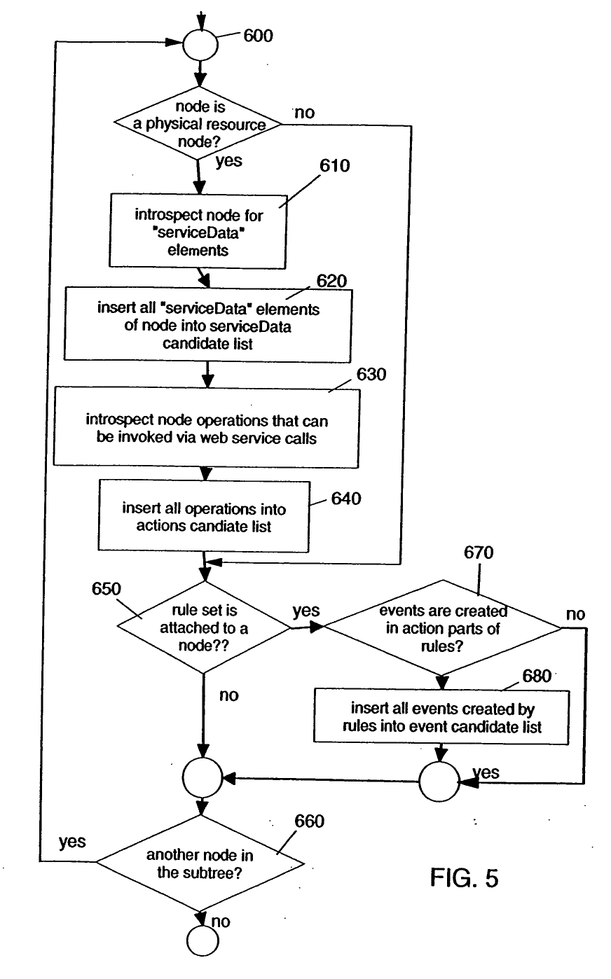

FIG. 4 provides an overview of this process. The detail will then be described with reference to FIGS. 5, 6 and 7.

With reference first to FIG. 4, a user can select a node of the topology tree and create a new rule set for managing the sub tree below that node 500.

Preferably rule sets are attached to logical nodes only. This is so that a subtree identified by a logical node can be managed using a rule set attached to that logical node—although it would be possible to attach a rule set to individual physical resources.

A rule set preferably has a unique identifier which makes it distinguishable from other rule sets; contains descriptions of events; and contains rules that are triggered by the described events. Note, rule sets may contain additional items and thus the afore-mentioned list is not intended to be limiting.

Thus at step 510, the editor traverses the subtree (associated with the node for which a new rule set is being created) and introspects the descriptions of all resources (resource descriptions are given as web service descriptions—e.g. WSDL) in order to collect a list of resources (members) defined by the SET; a list of the SDEs provided by all such resources; a list of actions that may be invoked on such resources; and a list of checks that may be queried of such resources. The collection of such data will be described in more detail later with reference to FIG. 5.

Note, the reason that the rule set is attached to a node up front (i.e. before the content of the rule set is defined) is so that the editor knows from which subtree it is to collect data.

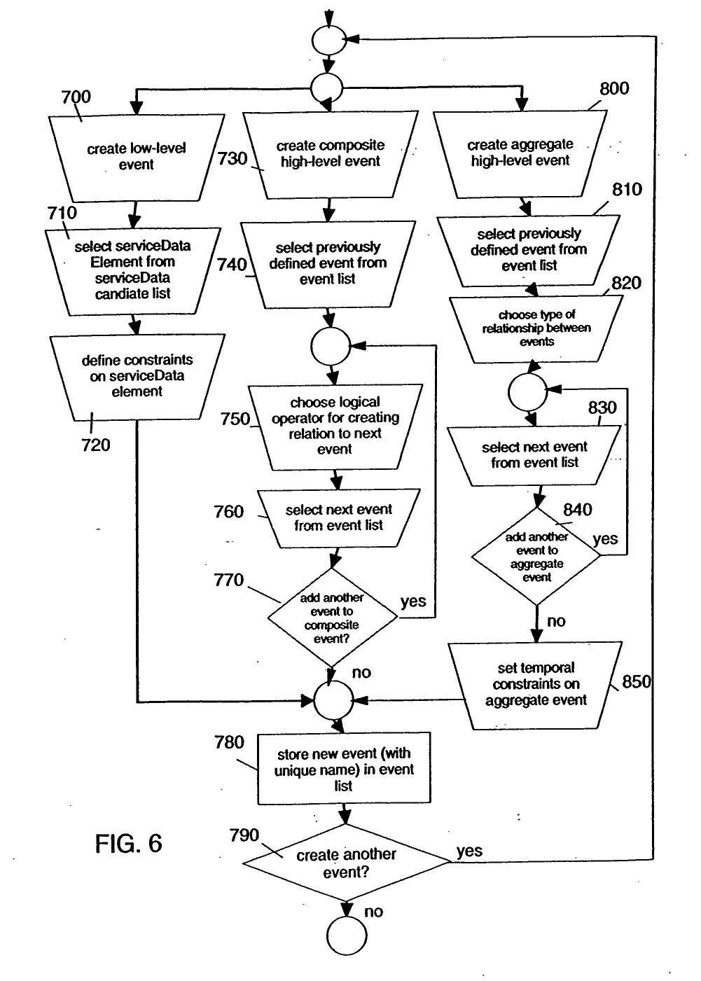

The SDEs can then be used by a user to define events that can trigger rules (step 520). The definition of events will be described further with reference to FIG. 6.

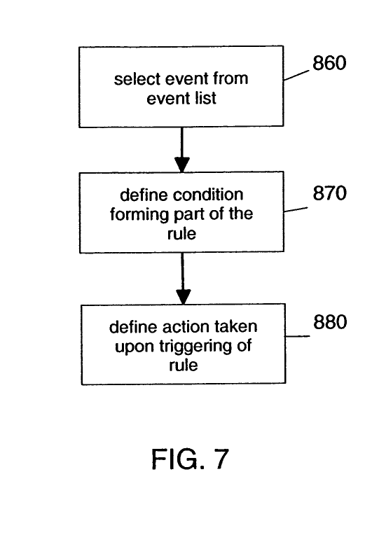

After events have been defined, rules can also be created (by the user) that are triggered by those events (step 530). This will be described later in more detail and with reference to FIG. 7.

The checks that are to be performed by rules can also be defined by the user. For example, rules can perform additional state queries on managed resources. The SDEs define which checks can be performed via active (management infrastructure driven) querying of SDEs.

Such state checks are queries of a resource's (or several resources') SDEs (as opposed to the resource initiated reporting of events). Thus, the SDEs provided by resources in a sub-tree, which are collected during tree traversal, can be used for defining the mentioned state checks. The user can select SDEs from a list (single one or a combination of several) and define checks that shall be performed. For example, for a rule triggered by Event CpuLoadHigh (i.e. cpuIdleTime<5%); the additional state check is to query if the free memory is for example below 10%. Thus the SDE freeMemory is selected from the list and the state check that shall be performed by the rule is defined.

Finally, actions (operations) that are to be triggered by a rule are defined by the user (not shown separately from step 530). Actions can be the creation of high-level events, the invocation of certain operations on resources or the execution of workflows. Again, possible single actions (operations) and actions that can be combined in a workflow are discovered by the editor by introspecting resources in the sub tree.

The process of creating rule sets (attached to particular nodes in the topology) can be repeated as often as needed (step 540). The result is a correlation model template for managing a service environment as described by the topology tree.

Step 510 of FIG. 4 will now be described in more detail with reference to FIG. 5.

Each node in the SET topology (below the node to which the new rule set is attached) is traversed using an arbitrary tree traversal algorithm—Note it is best if rule sets are attached to nodes in the topology tree in a bottom up order. This is so that events generated by rules defined for lower level nodes can be used to trigger rules in higher level nodes—see later.

At step 600, it is determined whether the node is a physical resource node. If the node is a physical one, then the “yes” branch is followed.

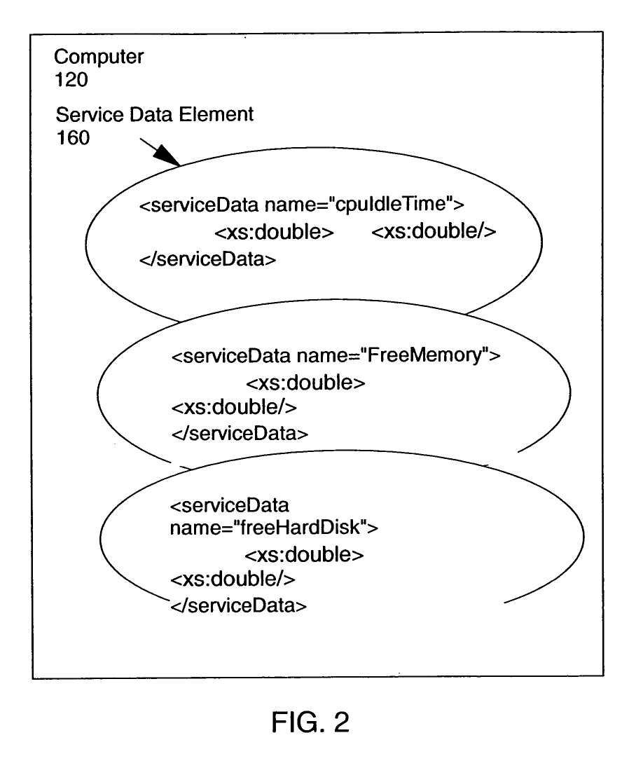

At step 610, the node is introspected to retrieve its service data elements (for example, the SDEs of FIG. 2—cpuIdleTime, FreeMemory, FreeHardDisk). It is possible to query SDE information via an interface provided to the topology tree information. The SDEs returned are then inserted into a serviceData candidate list. Note, only an identifier (which also acts as a pointer) to the underlying detail is preferably added into the list. Note, information is also returned regarding which resources are defined by the SET and this information is added into a members list (not shown separately). Links are made between members and their SDEs.

Note, if there are multiple resources of the same type (e.g. computer resources), then they are likely to provide the same SDEs (with the same name—e.g. cpuIdleTime). References to such SDEs are preferably only entered into the serviceData candidate list once.

The node is also introspected at step 630 in order to determine the operations that can be invoked, via web service calls, on a resource (e.g. to start a process). These operations (i.e. identifiers thereto) are inserted into an actions candidate list (step 640).

It is also possible that a node may already have a rule set defined—either defined earlier by a user using the editor or manually by a programmer and read in as part of the SET. Thus at step 650, this is verified. If there is no such rule set attached to the node, then it is determined whether there is another node in the subtree being traversed (step 660). The process either loops round (to step 600) or ends.

Note, if it was determined at step 600 that the resource is a logical one then the process proceeds to step 650—see above. The process could proceed to step 610 but there is little point since logical resources don't typically have associated SDEs etc. (hence the steps of 610 to 640 would find nothing).

If at step 650, it is determined that there is a rule set attached to the node—see above), then the process proceeds to step 670.

At step 670, it is determined (for the particular node being introspected) whether events are created in the action parts of the rules. Rules are typically given in a pattern such as: IF condition is true THEN execute ACTION1 [ELSE execute ACTION2] (the ELSE branch is optional). A rule is triggered by an event. ACTIONn can be: execute action; execute workflow; create higher-level event. Thus at step 670, it is determined whether it is intended that an event is created as a result of an action on a rule. Such events are ones that are used by rules higher up the tree in the situation that the particular node in question cannot resolve a conflict. For example, if it is detected by a rule that a particular set of computers are overloaded and there are no more free resources available AND if the particular logical node grouping the set of computers together does not have the authority/knowledge to solve the problem, then the rule (attached to the logical node as part of a rule set) creates an event informing a higher level node “there is a problem”.

At step 680, any such events are inserted by the editor into an event candidate list. Note, it is only an event identifier that is preferably inserted and this identifier provides a pointer to that event's definition.

Building upon the previous example, the user may be attaching a new rule set to the Web Hosting Environment node 10. When the subtree for this node is traversed, it may be discovered that a rule set has already been attached to the Web Server Group node 30. One such rule may initiate the return of an error when CPUHighLoad has been detected but it is not possible to add a new resource to the group in order to alleviate the problem. By inserting a reference to such an error event into the Web Hosting Environment's event candidate list, it is possible to use this event to trigger the Web Hosting Environment to execute a rule when this event is detected—for example, a rule which removes a resource from the Application Server Group and adds it to the Web Server Group.

Having added the event into the event candidate list, it is determined whether there is another node in subtree to traverse (step 660). If the answer is no, then the process ends. Otherwise, the process loops round again to step 600.

As previously alluded to, once all the data has been collected (step 510 of FIG. 4), the user defines events that can trigger rules (step 520 of FIG. 4). This process will now be described in more detail and with reference to FIG. 6.

Note, as previously alluded to events may be created as a result of rules in a subtree. If no events are created by rules, then only the list of SDEs provided by the resources in the subtree is available—these are not yet events.

Events can be:
1. countdowns or timers (for triggering rules that perform periodic checks);
2. simple low-level events (i.e. simple state changes of resources indicated through changes of single SDEs)—e.g. that the cpuIdleTime of a resource is below or above a certain limit. Such low-level events are defined (by the user) for a particular resource and are based on the SDEs provided by that resource. Once defined, such low level events are referenced in the event candidate list and a pointer is provided to the relevant resource(s) in the members list.
3. composite high-level events (state changes of resources indicated through a change of a combination of SDEs)—e.g. that the cpuIdleTime of a resource is below or above a certain limit AND that the freeMemory of the resource is below a certain percentage of the total memory of that resource (based on the cpuIdleTime SDE AND the FreeMemory SDE shown in FIG. 2). Low level events based on such SDEs will already have been defined and form part of the event candidate list. Thus such events can be selected and used when defining composite high-level events. Once defined, such composite high-level events are referenced in the event candidate list (and associated with the appropriate resource(s) in the members list). (Note, composite events can also be created directly from SDEs.)
4. aggregate high-level events (a combination of several composite high-level or low-level events that occur within certain temporal boundaries); and
5. high-level events that are created by rules (as described earlier).

By way of example with regard to an event of type one, a TimerEvent t1 could be defined that is generated by the management infrastructure every 10 minutes. Then a rule could be defined that is triggered by that timer and that performs some periodic checks.

By way of another example, a rule R1 could be defined that is triggered by some event; then R1 starts some action and sets up a countdown c1. c1 expires after a period of time and management infrastructure generates a countdown event. Then there could be a rule R2 that is triggered by that countdown event and checks if actions of R1 have been successful.

Note, the way in which this is achieved is preferably using normal programming constructs already well-known to one skilled in the art. The editor preferably provides the user with the ability to define the length of such a timer. The event raised upon expiry of such a timer is raised by the management infrastructure. The event does not need to be defined by a user, since the management infrastructure already knows how to raise such an event. However a reference to the event does need to be added into the appropriate event candidate list so that a user can use the event to trigger appropriate rules. The user defines the timer length and the system allocates the timer a unique identifier which is inserted into the event candidate list.

Event types 3 and 4 are preferably defined based on previously defined events referenced in the event candidate list. Such previously defined events were defined based on SDEs provided by the resources of a service environment, especially by the resources in that part of the service environment that is described by the sub tree below the node the rule set is attached to.

Further, events of type 4 can be defined based on any previously defined event in the event candidate list.

Events of type 5 can be created as a result of rules (e.g. by actions/workflows defined by the management infrastructure). If it is not possible to solve a problem in the scope of the sub tree that a rule set is attached to, a rule can exist that creates an event that can trigger a rule in a higher-level rule set. Hence, when traversing a sub tree the editor also collects all events that are created by rules contained in rule sets that are attached to nodes of that sub tree. For this reason, it is best if rule sets are defined in bottom up order.

With reference now to FIG. 6, the event creation process will now be described.

Low-Level Events (Type 2)

It is determined at step 700 that a low level event is to be created. At step 710, the appropriate serviceData Element is selected from the serviceData candidate list created at step 620 of FIG. 5.

Furthermore, constraints on such SDEs are defined, e.g. value must be greater than x, value must be less than y. This is done at step 720 of FIG. 6.

Once a low level event has been created, the unique identifier (name) allocated to it is stored in the event list created at step 680 in FIG. 5 (step 780) and dependent upon whether or not there are more events to be created, the process either loops back round or ends.

Composite High-Level Events (Types 3)

Composite high-level events are created at step 730. As previously discussed, a composite high-level event comprises two or more low-level events joined by one or more logical operators (e.g. AND, OR). Thus at step 740, a low-level event is selected from the previously defined event list (see step 710). A logical operator is then selected (step 750) in order that this event can be linked to another event selected at step 760. More events can then be added to the composite event (branch 770).

Once the composite event has been created, the unique identifier allocated to it is stored in the event list (step 780). The process then either loops round, or ends (step 790).

Aggregate High-Level Events (Type 4)

An aggregate event is created at step 800. A previously defined event is selected from the event list (step 810). At step 820 it is decided what the relationship should be between any selected events—for example that all events should be created by the same resource; and/or (any logical connector) that all events should originate from customer A only etc.

The editor preferably provides the user with a number of choices as to type of relationship and the user can select the appropriate one(s).) Furthermore, the editor offers the possibility for users to define their own relationships, e.g. using programming language constructs.

It is then determined whether another event should be added to the aggregate event (step 840) and if the answer is “yes”, then the process loops round to step 830.

Otherwise, temporal constraint(s) are then placed upon the aggregate event (step 850)—for example that all the events must have been generated within the last 10 minutes.

Once the aggregate event has been fully created, the event (i.e. its unique identifier) is stored in the event list (step 780) and the process either loops round or ends (step 790).

Thus as previously alluded to, each event is provided with a unique identifier (e.g. cpuHighLoad) and the form of such an event is then defined based on resource SDEs (e.g. cpuIdleTime<5% and freeMemory<10%).

For instance, the computer resource of a web server (as shown in FIG. 2) provides (among others) the two SDEs “cpuIdleTime” (in %) and “Free Memory” (in %).

By way of example, the following events could be defined:
type 2: Event “CPU Load high” when SDE “cpuIdle” of a computer is below 10%;
type 3: Event “computer overloaded” when SDE “cpuIdleTime” of a computer is below 10% and the SDE “Free Memory” is below 5%; and
type 4: Event “critical computer overload” when event “computer overloaded” is detected ten times within one minute.

At runtime SDEs are provided by resources to the management infrastructure which examines such SDEs to determine whether there are any matches against event definitions provided by an instantiated correlation model.

Note, although this is not explicitly shown in any of FIG. 4 to FIG. 6, during the event (rule) definition process, the user is presented with the list of resources (from the members list) described by the SET. The user can select a resource from this list and is then presented with SDEs (from the SDE list) provided by the selected resource. Information regarding the available SDEs is extracted from the serviceData candidate list. E.g. the “computer” member provides the three SDEs from FIG. 2. Such SDEs can then be used to define events (as described above). Note if, for example, two SDEs are used to define an event based on the same computer resource, then the editor indicates that such events should be generated by the same resource. The same process is preferably used with regard to the selection of operations when defining actions executed as part of rules. Thus herein when it is said that something is selected from an SDE list, event list or actions list, this should be taken to mean that relevant SDEs, events, actions are presented to the user from the appropriate list based on a member selected from the members list.

As previously discussed having defined appropriate events, rules (which form part of a particular rule set) which are triggered by events can then be defined (see step 530). This process will be further described with reference to FIG. 7.

At step 860 an event is selected from the event list created in FIG. 5 at step 680 and FIG. 6 step 780. Note, it is not necessary to associate the event with a particular resource since the rule set which is to include the event identifies a subtree in the SET topology and only certain resources within the subtree will produce appropriate events. The next step 870 may further select the particular resource from a plurality of the same type (e.g. from 5 computers).

A condition may be defined which forms part of the rule (step 870). Conditions typically include Boolean expressions and may be defined using ordinary programming constructs well known to those skilled in art. The editor preferably provides the user with a toolbox of logical operators and proforma conditions from which to select.

Then an action is defined which is to be taken upon such a condition being met (step 880)—for example, when cpuIdleTime for the WebServer Computer is below 10%, load new resource from pool of free resource (not shown). Such an action may be selected from the actions list and when the rule set is instantiated, the management infrastructure understands how to perform such a selected action—the action/a workflow is defined within the management infrastructure and the CMT provides only a pointer to such an action/workflow.

Thus all of the information defined by following the processing of FIGS. 4, 5, 6 and 7 is used by the CMT Editor 310 to create a Correlation Model Template 320. This is achieved by the CMT Editor translating the user defined information (i.e. the rules, events, actions) into a WSDL/XML or the like document. Note, additional non-user defined information may also be translated by the CMT Editor—for example, information regarding hierarchical dependencies between rule sets created by the editor. This information can be deduced by the editor from the form of the SET topology. Such information can then be used to propagate information higher up the topology to resolve conflicts that cannot be solved at the lower level.

Note, the translation process will not however be described in detail herein since this process would be clear to a person skilled in the art.

Thus as previously alluded to, the CMT preferably comprises:
i) one or more rule sets attached to nodes in the SET;
ii) members—i.e. resources associated with mentioned rule sets (SDEs)
iii) event descriptions associated with mentioned rule sets;
iv) event patterns (aggregate events) associated with mentioned rule sets; and
v) rules contained in mentioned rule sets

Note, the CMT editor preferably provides a graphical user interface (GUI) for creating a CTM. The SET is preferably depicted graphically in the form of a tree of nodes. The user is then able to select nodes in the tree and create new rule sets (attached to the respective nodes) which describe how the subtrees below these nodes are to be managed.

When a new empty rule set is created, the editor presents to the user a list of members (resources within the sub-tree); a list of SDEs provided by a selected member; a list of events generated by rules associated with a selected member within the sub tree (rule sets in which events are created may be attached to lower-level nodes)—this list will later be expanded by the events the user defines; a list of operations that can be invoked on a selected member.

Note, because only valid and present data is presented to the user, this ensures that the final correlation model is correct. With prior art solutions the user had to code everything manually—this meant that the possibility of error was greatly increased since it was easy enough, for example, to incorrectly type the name of an SDE or try to select an SDE that didn't actually exist.

From the SDEs presented the user can select SDEs and define events (see FIG. 6). These events will then be added to the event list.

From the events presented the user can select events and create rules triggered by these events. When specifying additional condition checks that shall be performed by the rule (the IF part), the user can also select SDEs from presented SDEs that shall be queried. When specifying the action part of the rule the user can select operation from the operation list; or create complex workflows as sequences of single operation taken from the operation list.

Thus it is possible to associated small rule sets with different parts of the SET topology.

It should be noted that each node to which a rule set is attached preferably has a separate set of lists (event list, SDE list etc.)

Example: A user creates rule set WebServerGroupRule set attached to node 30 in FIG. 1. The following list is then presented to the user:

Members (Resources in Sub Tree):

LoadBalancer
WebServer
   Web Server Software
   Operating System
   Computer
      SDEs:
Computer:cpuIdleTime
Computer:freeMemory
Computer:freeHardDisk
LoadBalancer:numberOfConnections
etc.
   Events:
CpuHighLoad (pointer to the definition)—cpuidleTime below 10% and freeMemory below 5%
CriticalCpuHighLoad (pointer to definition)—CpuHighLoad event occurs 10 times within 1 minute
(Note, these events are defined by the user, they are not there initially. All the events provide a pointer to the actual definition of the event.)
   Operations:
Computer:startUp
Computer:shutDown
OperatingSystem:startProcess
OperatingSystem:stopProcess
AddNewResourceFromFreeResourcePool
CreateEvent X
etc.
X denotes an event—e.g. WebServerGroupProblem—that can be propagated up the SET topology tree. Propagation occurs as soon as there is a rule defined at a higher level node that is triggered by the event. (Note a link between the two rule sets is automatically established by a work flow during instantiation. It is recognized that: “Rule R1 in RuleSet1 creates event E1”+“Rule R2 in RuleSet2 is triggered by event E1” →create link between RuleSet1 and RuleSet2.) If no rule is defined, then CreateEvent doesn't do anything)

Note, regarding the SDES, events and operations—appropriate ones are presented to the user when the user selects a relevant resource in the subtree for which the rule set is being created (see earlier).

In order to define the CpuHighLoad and CriticalCpuHighLoad events, SDEs can be selected from the SDE list and constraints defined (or alternatively, low level events based on these SDEs could already have been defined and placed in the events list). Please see FIG. 6 for a more detailed explanation.

The user can then define rules which form part of the WebServerGroupRulesSet and which are triggered by such events. In order to do this, the user selects events of interest from the event list—for example CpuHighLoad. Having selected appropriate events, the user is able to define conditions that are to be performed upon detection of the event. Subsequently, the user defines which actions are to be taken upon triggering of the rule (and defined conditions being met). The user can do this by selecting operation(s) from the actions list and also by selecting workflows. (Note, it would be possible to have a separate list of workflows or this could form part of the actions list). As alluded to earlier workflows/actions are preferably defined by the producer of a resource and sit within the management infrastructure.

The definition of rules was described in more detail with reference to FIG. 7.

In this way it is possible to associate rule sets with individual tree nodes.

Note, the creation of high level events will now be explained in more detail.

The user may for example define the following rules as part of the WebServerGroup rule set:

ON CpuHighLoad: IF (cpuIdleTime of all computers in group is below 10%) THEN “AddNewResource”

If Error create event “NoMoreResources”

Note, the “NoMoreResources” event is not defined by the user, but is created by the management infrastructure, e.g. in case the AddNewResource workflow failed because no more free resources were available)

Further note, the ON is optional. There may also be rules that only check conditions (IF). These rules are usually executed after other rules have been processed. In addition there are also rules where the ON is there but the IF is missing.
As a result there a three main types of rules:
ON . . . IF . . . then do action
IF . . . then do action . . . and
ON . . . do action

It will be appreciated that there a various known rule scheduling algorithms that could be used.

Thus when, a rule set is attached to the Web Hosting Environment node 10, nodes in the subtree below are traversed to determine whether a rule of the type defined above exists. The “NoMoreResources” event is thus added into the event list created for node 10. This event can then be used to define rules which are triggered on receipt of the event at the Web Hosting Environment node from a lower level node (e.g. the WebServer Group node).

Transformation CMT→CMD (Arrow [B] in FIG. 3)

The newly created CMT is then fed into the Correlation Model Definition Composer 330 in order that a Correlation Model Definition (CMD) 340 can be created.

As mentioned earlier, several parts of the correlation model template can be left blank (e.g. constraints in event definitions; constraints in condition parts (IF parts) of rules; parameters for operations and workflows). These parts are later filled in according to specific SLAs 350 and provider policies 340. This shall be explained using the example events mentioned earlier.

The event definitions may look as follows:
Event “CPU Load high” when SDE “cpuIdleTIme” of a computer is below a %;
Event “computer overloaded” when SDE “cpuIdleTime” of a computer is below a % and the SDE “Free Memory” is below b %;
Event “critical computer overload” when event “computer overloaded” is detected c times within one minute.

a, b and c all denote variable parts of the event definitions. These blanks are filled in according to SLAs. For a customer A with an SLA for a high-performance service the replacements could be a=20, b=20 and c=5.

For a customer B with an SLA for a low-performance service the replacements could be a=5, b=5 and c=20.

As a result, customer A's events would be detected earlier and rules (associated with those events) for, for example, adding new resources would also be triggered earlier.

The CMD composer takes the newly created CMT, an SLA(S) and/or policy(ies) as input and uses these to create a CMD.

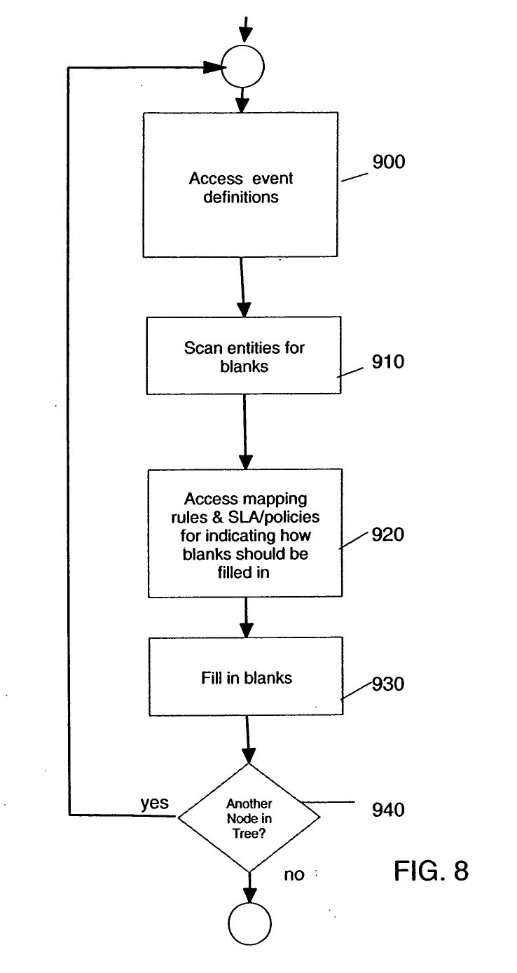

This process will be described with reference to FIG. 8.

The CMD Composer 260 accesses for each node in the tree in the CMT the event definitions, rules (especially the conditions), any workflow/action identifiers and any parameters associated with the identified workflow/actions (e.g. a workflow states that more resources should be added, a parameter on the workflow states exactly how many resources to add) (step 900) and then scans each appropriate entity looking for blanks (step 910). Note, the workflow/action identifiers are used by mapping rules which define which parameters of which workflows have to be filled in according to which SLA/policy values.

The CMD Composer then accesses the SLA(s) and policy(ies) associated with a particular customer, along with some mapping rules (step 920). The combination is then used to determine how the blanks should be filled in (step 930)—e.g. constraints on specific SDEs in event definitions. (By way of example, customer A may require a high-level of performance such as response times of below 2 seconds. This might be specified in their SLA. The CMD Composer would translate this information into certain values being entered into the blanks for cpuidletime and FreeMemory SDEs.)

It is then determined whether there is another node in the tree (step 940) and if necessary the process loops round. Otherwise it ends.

The composer also creates workflows for instantiating a correlation model in a specific correlation (management) infrastructure. Workflows are needed, for example, for instantiating rule sets, associating rule sets to specific resources or for creating associations between separate rule sets that have hierarchical dependencies.

Note, a workflow engine (not shown) executes the created workflows. The management infrastructure provides all the single operations that are called from within a workflow.

The processing for creation of a workflow will be well understood to one skilled in the art and will not therefore be described in more detail herein. What is unusual however is the fact that such functionality is provided in the CMD composer, thereby enabling the CMD composer to create such workflows automatically and for arbitrary management infrastructures 390. Note, it is preferably the CMD composer provides the ability to create such workflows since then it is possible for the CMD composer to tailor any newly created workflows to the particular management infrastructure in which a final correlation model is to be instantiated. The CMD Composer is preferably provided with an appropriate plugin in order that the final executing correlation model instance is tailored to the particular management infrastructure in operation. Thus multiple correlation models can be instantiated for different management infrastructures but from the same CMD.

The composer is also able to create CMD deltas if SLAs or policies change during the runtime of a service environment.

The delta is preferably created using the new SLA/policies etc. Delta mapping rules are preferably provided in the CMD composer, which indicate how the variable values in the CMD should be changed. For example, if customer B upgrades from a low-performance service level SLA to a high-performance service level SLA then value a should be changed from 5 to 20, value b from 5 to 20 and value c from 20 to 5 (see earlier example). Such deltas can then be applied to an instantiated correlation model using workflows also created by the composer.

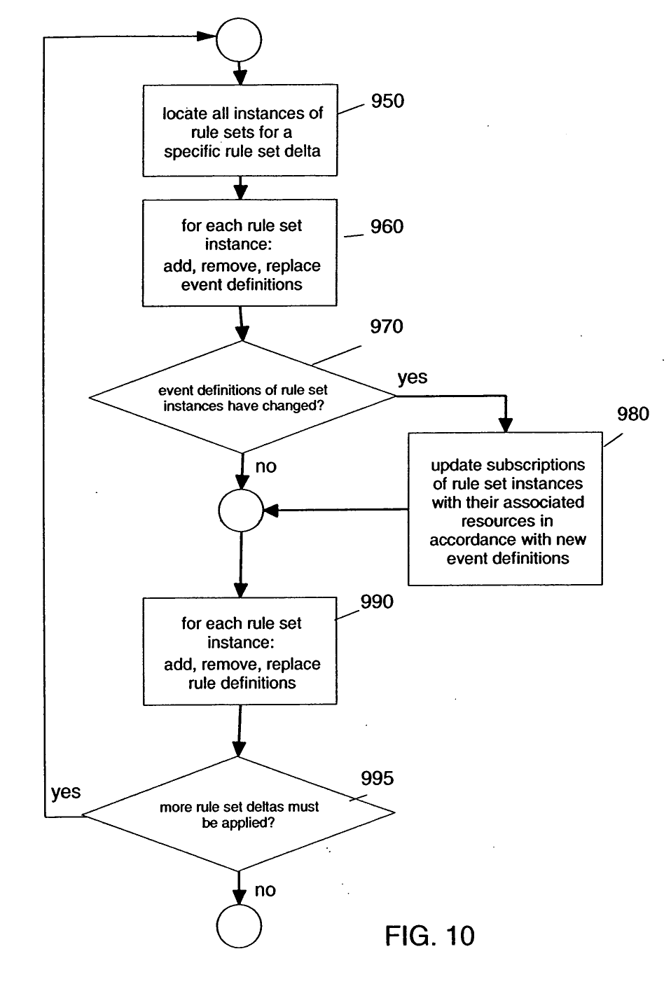

The application of a CMD delta will be described in more detail later with reference to FIG. 10.

Instantiation of CMD (Arrow [C] in FIG. 3)

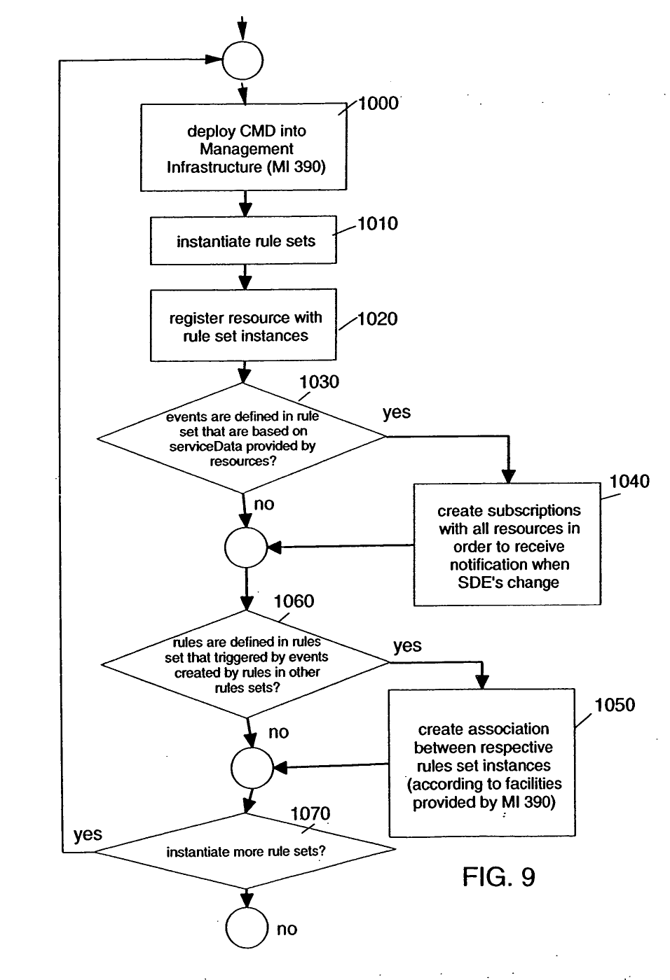

With reference now to FIG. 9, the CMD created by the CMD Composer is deployed into the correlation infrastructure 390 (step 1000) and can be instantiated using the workflows created by the CMD Composer.

In contrast to prior art solutions, instantiation is now an automatic process. There is no administrator required to instantiate rule set X and add resource Y to X. This is all done by work flows.) There are rules in the CMD composer that define the form that the workflows should take. E.g. for each defined rule set there must be a step in the workflow for instantiating the rule set. For each member of a rule set there must be step in the workflow which adds the resource to the rule set instance etc.

A different plugin is used for each different management infrastructures for example to define how specific operations invoked by workflows are called within a specific management infrastructure. Example: Infrastructure 1 provides operation “InsertResourceIntoRuleSetInstance” while infrastructure2 provides “AddResoourceToRuleSetInstance”. A different plugin is used for each infrastructure to define an appropriate mapping.

The following workflows should preferably be executed by a workflow execution engine in order to instantiate a correlation model definition as a correlation model instance:

Instantiate Rule Sets (Step 1010):

Rule sets defined in a CMD have to be instantiated. (Note, the difference between a ruleset in the CMT and its equivalent in the CMD, is that the CMD version has the variable parts filled in.) Each instance of a rule set receives a unique identifier which makes it distinguishable from other rule set instances. Note that multiple instances of a certain type of rule set can be created. For example, if multiple web server groups exist in a service environment, one instance of the rule set for managing a web server group is preferably created for each web server group. Likewise, several customers may exist, each employing web server groups in their service environments. The instantiation of rule set instances in accordance with rule set definitions is similar to the instantiation of software objects according to class definitions in object-oriented programming. The management infrastructure is able to interpret the rule sets provided and to instantiate these as appropriate;

Associate Rule Set Instances with Managed Resources (Step 1020, 1030, 1040):

After a rule set has been instantiated it has to be associated to specific resource(s) of the service environment. This is achieved by registering resources' handles with the rule set instance. These resource handles can then be used by rules, e.g. for performing state queries on the registered resources. For example, handles of resources that belong to WebServerGroup1 (existing in the running service environment) are added to rule set instance WebServerGroupRuleSetl.

Note, the SET describes e.g. how many computer resources initially belong to WebServerGroup. Then a workflow defines, how these resources are registered with WebServerGroup1: “take 5 computers from free pool; add these 5 resources to WebServerGroup1 (logical entity; is modelled within management infrastructure, e.g. using database relations); register handles of these 5 computers with rule set instance WebServerGroupRuleSetl etc.”

Thus workflows/action instances should preferably know the capabilities of the management infrastructure in which they operate and how rule sets are registered. This is why workflows and CMDs are preferably created by the same entity (The CMD Composer)—in order to make sure that the respective management infrastructure understands the information provided by the CMD. The instantiated correlation model is tailored to the particular infrastructure in which it operates. The Correlation Model Definition Composer preferably has a different plugin for each infrastructure in which it instantiates correlation model instances.

If events are defined in a newly instantiated rule set that are based on SDEs provided by such resource(s) (step 1030), then subscriptions have to be created with all such resources in order to receive notification when a resource's SDE changes (i.e. the value)—step 1040. In this way it is possible to receive monitoring events from the resources. The processing then proceeds to step 1060 (see later).

If no events are defined which are based on SDEs provided by the resources (step 1030), then it is determined (using information contained in the CMD) whether rules are defined in rules set that are triggered by events created by rules in other sets (step 1060). If this is not the case, then it is determined whether there are more rule sets to be instantiated (step 1070). If so, the process loops back round again to step 1000, otherwise the process ends.

Note, for the situation in which rules are defined in rules set which are triggered by events created by rules in other rules sets (step 1060), please see later.

Example: A rule set “WebServerGroupRuleset” is defined that describes how a web server group shall be managed. An event “WebServerGroupOverload” is defined that exists, if 80% of the group's web servers have a cpuIdleTime lower than 10%. After creating an instance I of the WebServerGroupRuleset, handles to resources of type computer are registered with I. Since the mentioned event is based on the value of the resources' cpuIdleTime SDE, subscriptions for that SDE are created with each resource, so that notifications about changes of that SDE are sent to I. On receipt of an event, I can then use the resource handles to query all registered computer resources and check if more than 80% of them have a CPU Load higher than 90%. In other words, once it has been determined that for one computer the load is greater than 90%, all other computing resources can be queried and their load averaged.

Associate Rule Sets with Each Other (Step 1060, 1050):

If rules in one rule set are triggered by events created by rules in another rule set (step 1060), an appropriate link between the two rule set instances has to be established (depending on the facilities of the correlation infrastructure)—step 1050. For example, if the correlation infrastructure uses a pub-sub system to communicate events between rule sets, actions have to be taken to ensure that rule set instance 11 publishes its events to the pub-sub channel and that rule set instance 12 receives those events from the pub-sub channel.

The process described by FIG. 9 repeats itself until there are no more rule sets to instantiate (step 1070).

As previously briefly discussed, CMD deltas can also be instantiated into the management infrastructure 390. CMD deltas are used to initiate change that occurs as a result of a change in an SLA(s)/provider policy(ies) This process will now be described in more detail below with reference to FIG. 10.

At step 950 all instances of rule sets that are affected by a specific rule set delta are located—for example, all rule sets for all webserver group instances belonging to customer A are accessed.

The event definitions are then added to, removed or replaced as defined by delta mapping rules provided in the CMD Composer (step 960).

If the event definitions for a rule set have changed (step 970), then the subscriptions of rule set instances with their associated resources are updated in accordance with the new event definitions (step 980) and the process then continues to step 990—see later.

Otherwise (step 970), for each rule set instance, rule definitions are added to, removed, replaced as appropriate (step (990).

Note, workflow/action parameters are also accessed, but this is usually done implicitly when changing a rule. The rule says that workflow X shall be invoked with parameter Y=5 and then if the rule is changed, then the action part of the rule and, thus, the workflow parameter is also changed.

Then, dependant upon whether more rule set deltas are to be applied (step 995), the process either ends or loops back round.

Example: A rule set “WebServerGroupRuleset” as mentioned earlier exists. A rule exists that is triggered by the “WebServerGroupOverload” event; this rule triggers a workflow that adds more resources to the web server group. When the CMD was initially composed an SLA for a high-performance service was used. Later the customer switched to a medium-performance SLA. As a result the WebServerGroupOverload event is detected only if 95% of all computers in the web server group have a cpuIdleTime of less than 10% (the value in the original event definition was e.g. 20%→old event is replaced by this new one). Hence, this new definition of the WebServerGroupOverload event is deployed into all instances of the WebServerGroupRuleset; the old event definition is removed.

As mentioned above, delta mapping rules within the CMD Composer define the necessary changes. For example, such delta mapping rules may define that the required “response time” is extracted from a particular SLA and that a 3 second response time indicates that this is a medium performance SLA. Such rules may then define that for a medium performance SLA certain event definitions should be updated with values x, y and z.

Changes (e.g. new SLAs) are passed to the CMD Composer by the user via a program interface. This initiates the creation of a CMD delta(s).

1. A method for facilitating a user in a creation of a model describing how resources in a service environment are to be managed by a resource management system, the method comprising the steps of:
receiving a service environment description comprising information defining resources that may be managed by the resource management system;
automatically extracting information from the description regarding services provided by at least some of the resources;
presenting a user with the extracted information; and
facilitating the user in the creation of the model and permitting the user to define rules for managing at least some of the resources.

2. The method of claim 1, further comprising the step of:
creating a correlation model template by defining rules for managing at least some of the resources, the correlation model template having variable parameters.

3. The method of claim 2, further comprising the steps of:
receiving input defining values of said variable parameters; and
outputting a correlation model definition having values defined for said variable parameters in accordance with the input received.

4. The method of claim 1, wherein the extracted information comprises service data elements, each service data element defining a service provided by a resource within a service environment.

5. The method of claim 4, wherein the extracted information further comprises operations which may be invoked on the resources, and wherein a rule, when defined, comprises an operation to be performed upon execution of the rule.

6. The method of claim 1 wherein the step of permitting the user to define rules comprises:
permitting the user to associate rules with certain resources.

7. The method of claim 1, wherein the step of permitting the user to define rules comprises the step of:
permitting the user to define an event which triggers an execution of a rule.

8. The method of claim 7 wherein the step of presenting a user with the extracted information comprises:
presenting to the user a list of service data elements provided by at least one resource in a service environment, such service data elements forming a basis for event definitions.

9. The method of claim 8, wherein the step of permitting the user to define an event comprises:
permitting the user to associate values with at least some of the service data elements listed.

10. The method of claim 1, further comprising:
compiling the model describing how the resources are to be managed into a machine readable form executable by said resource management system as a correlation model instance.

11. The method of claim 10, wherein the created model includes variable parameters and wherein the step of compiling the model into a machine readable form comprises:
receiving input defining values of the variable parameters; and
outputting a correlation model definition having values defined for said variable parameters in accordance with the input received, said output correlation definition model in the machine readable form executable by said resource management system as the correlation model instance.

12. The method of claim 11, wherein the input received is from a service level agreement and/or a provider policy.

13. The method of claim 10, further comprising:
creating at least one workflow to define how the model is to be executed as a correlation model instance.

14. The method of claim 13, further comprising the step of:
instantiating and executing the correlation model using at least one of said at least one created workflow.

15. The method of claim 10, further comprising the steps of:
determining that a change is to be applied to an executing correlation model instance;
creating a correlation definition model delta based on newly received input; and
applying the correlation definition model delta to the executing correlation model instance.

16. A computer program comprising program code means adapted to perform the method of claim 1 when said computer program is executed on a computer.

17. A computer program product stored on a computer readable medium comprising instructions which, when executed on a data processing host, cause said host to carry out a method according to claim 1.

18. An apparatus for facilitating a user in a creation of a model describing how resources in a service environment are to be managed by a resource management system, the apparatus comprising:
means for receiving a service environment description comprising information defining resources that may be managed by the resource management system;
means for automatically extracting information from the description regarding services provided by at least some of the resources;
means for presenting a user with the extracted information; and
means for facilitating the user in the creation of the model by permitting the user to define rules for managing at least some of the resources.
